(19) United States
(12) Patent Application Publication
(10) Pub. No.: US 2026/0169195 A1
(43) Pub. Date: Jun. 18, 2026

(54) ANTI-REFLECTION FILM AND DISPLAY DEVICE INCLUDING THE SAME

(71) Applicant: SAMSUNG DISPLAY CO., LTD., YONGIN-SI (KR)

(72) Inventors: Hyeon Mi LEE, Yongin-si (KR); Da Hye KIM, Chigasaki-shi (JP); Man Soo KIM, Chigasaki-shi (JP); Jung Hyun KIM, Chigasaki-shi (JP); Hyun Hyang KIM, Yongin-si (KR); Ju Young YOON, Yongin-si (KR)

(21) Appl. No.: 19/312,678

(22) Filed: Aug. 28, 2025

(30) Foreign Application Priority Data
Dec. 16, 2024 (KR) 10-2024-0186651

(51) Int. Cl. G02B 1/111; G06F 3/041

(52) U.S. Cl. CPC G02B 1/111; G06F 3/041

(57) ABSTRACT

An anti-reflection film includes an anti-fingerprint film. A first refractive layer is arranged on a first surface of the anti-fingerprint film. A second refractive layer is arranged on the first refractive layer. A refractive index of the first refractive layer is less than a refractive index of the second refractive layer. The first refractive layer comprises silicon oxide (SiOₓ) doped with metal in a range of less than or equal to about 3 at %.

This application claims priority under 35 U.S.C. § 119 to Korean Patent Application No. 10-2024-0186651, filed on Dec. 16, 2024 in the Korean Intellectual Property Office, the disclosure of which is incorporated by reference in its entirety herein.

### 1. TECHNICAL FIELD

The present disclosure relates to an anti-reflection film and a display device including the same.

### 2. DISCUSSION OF RELATED ART

The demands for display devices have increased along with the advancement of the information-oriented society. For example, display devices are being applied to an increasing variety of electronic devices, such as smart phones, digital cameras, laptop computers, navigation devices, and smart televisions.

When a display device is exposed to external light such as various artificial illumination lights and natural light, the image created in the display device may not be clearly seen by the user due to reflected light, or may cause fatigue to the user's eyes. Therefore, the demand for a display device with anti-reflection properties is increasing.

### SUMMARY

Aspects of the present disclosure provide an anti-reflection film with increased hardness and durability.

It should be noted that objects of embodiments of the present disclosure are not limited to the above-mentioned object; and other objects of embodiments of the present disclosure will be apparent to those skilled in the art from the following descriptions.

According to an embodiment of the present disclosure, an anti-reflection film includes an anti-fingerprint film. A first refractive layer is arranged on a first surface of the anti-fingerprint film. A second refractive layer is arranged on the first refractive layer. A refractive index of the first refractive layer is less than a refractive index of the second refractive layer. The first refractive layer comprises silicon oxide (SiOx) doped with metal in a range of less than or equal to about 3 at %.

In an embodiment, light is incident from outside on a second surface of the anti-fingerprint film that is opposite to the first surface of the anti-fingerprint film.

In an embodiment, the metal includes at least one compound selected from zirconium (Zr), titanium (Ti), aluminum (Al), hafnium (Hf), gallium (Ga), and indium (In).

In an embodiment, the anti-fingerprint film includes a compound having at least one silanol at a terminal. A hydroxyl group (—OH) is formed on a surface of the first refractive layer. The silanol bonds with the hydroxyl group (—OH).

In an embodiment, the first refractive layer is uniformly doped with the metal.

In an embodiment, a thickness of the first refractive layer is less than or equal to about 200 nm.

In an embodiment, the first refractive layer includes: a first sub-layer including silicon oxide (SiOₓ) doped with the metal in the range of less than or equal to about 3 at %; and a second sub-layer located on a first surface of the first sub-layer and including the silicon oxide (SiOₓ). A second surface of the first sub-layer that is opposite to the first surface of the first sub-layer is in direct contact with the anti-fingerprint film.

In an embodiment, a thickness of the first refractive layer is in a range from about 70 nm to about 200 nm, and a thickness of the first sub-layer is less than or equal to about 100 nm.

In an embodiment, a thickness of the anti-fingerprint film is less than or equal to about 35 nm.

In an embodiment, the first refractive layer is non-uniformly doped with the metal.

In an embodiment, the metal has a gradual concentration gradient in the first refractive layer.

In an embodiment, the gradual concentration gradient increases towards the anti-fingerprint film.

In an embodiment, the gradual concentration gradient decreases towards the anti-fingerprint film.

In an embodiment, the gradual concentration gradient increases towards a center of the first refractive layer in a thickness direction of the first refractive layer.

In an embodiment, the anti-reflection film further includes: a third refractive layer located on the second refractive layer; and a fourth refractive layer located on the third refractive layer, wherein a refractive index of the third refractive layer is less than a refractive index of the fourth refractive layer.

According to an embodiment of the present disclosure, a display device includes a display panel. An anti-reflection film is arranged on the display panel. A window member is arranged on the anti-reflection film. The anti-reflection film includes an anti-fingerprint film. A first refractive layer is arranged on a first surface of the anti-fingerprint film. A second refractive layer is arranged on the first refractive layer. A refractive index of the first refractive layer is less than a refractive index of the second refractive layer. The window member is arranged on a second surface of the anti-fingerprint film opposite to the first surface of the anti-fingerprint film. The first refractive layer includes silicon oxide (SiOₓ) doped with metal in a range of less than or equal to about 3 at %.

In an embodiment, the first refractive layer includes: a first sub-layer including silicon oxide (SiOₓ) doped with the metal in the range of less than or equal to about 3 at %. A second sub-layer is located on a first surface of the first sub-layer and includes the silicon oxide (SiOₓ). A second surface of the first sub-layer that is opposite to the first surface of the first sub-layer is in direct contact with the anti-fingerprint film.

In an embodiment, the metal has a gradual concentration gradient in the first refractive layer.

In an embodiment, a third refractive layer is located on the second refractive layer. A fourth refractive layer is located on the third refractive layer. A refractive index of the third refractive layer is less than a refractive index of the fourth refractive layer.

According to an embodiment of the present disclosure, an electronic device includes a display device for displaying images. The display device includes a display panel. An anti-reflection film is arranged on the display panel. A window member is arranged on the anti-reflection film. The anti-reflection film includes an anti-fingerprint film. A first refractive layer is arranged on a first surface of the anti-fingerprint film. A second refractive layer is arranged on the first refractive layer. A refractive index of the first refractive layer is less than a refractive index of the second refractive layer. The window member is arranged on a second surface of the anti-fingerprint film opposite to the first surface of the anti-fingerprint film. The first refractive layer includes silicon oxide (SiOₓ) doped with metal in a range of less than or equal to about 3 at %.

According to an embodiment of the present disclosure, it is possible to increase adhesive strength between an anti-reflection film and an anti-fingerprint film by placing a low-refractive layer doped with a metal of a low content at the top layer of the anti-reflection film. According to an embodiment of the present disclosure, it is possible to prevent an anti-fingerprint film from falling off due to repeated physical friction by increasing the adhesive strength between the anti-reflection film and the anti-fingerprint film.

It should be noted that effects of the present disclosure are not limited to those described above and other effects of the present disclosure will be apparent to those skilled in the art from the following descriptions

### BRIEF DESCRIPTION OF THE DRAWINGS

The above and other aspects and features of the present disclosure will become more apparent by describing in detail non-limiting embodiments thereof with reference to the attached drawings, in which:

FIG. 1 is a plan view of a display device according to an embodiment of the present disclosure.

FIG. 2 is an exploded, perspective view of a display device according to an embodiment of the present disclosure.

FIG. 3 is a side view of a display device according to an embodiment of the present disclosure.

FIG. 4 is a cross-sectional view of a display panel according to an embodiment of the present disclosure.

FIG. 5 is a cross-sectional view showing an anti-reflective film in a display device according to an embodiment of the present disclosure.

FIG. 6 is an x-ray photoelectron spectroscopy (XPS) graph when metal (Zr, Yi, Al) is doped into silicon oxide (SiO₂) according to an embodiment of the present disclosure.

FIG. 7 is a view showing a method for forming an anti-fingerprint film on a first refractive layer according to an embodiment of the present disclosure.

FIG. 8 is a view showing a method for forming an anti-fingerprint film on a first refractive layer according to Comparative Example.

FIG. 9 is a cross-sectional view showing an anti-reflective film in a display device according to an embodiment of the present disclosure.

FIG. 10 is a view showing an anti-reflective film in a display device according to an embodiment of the present disclosure.

FIG. 11 is a view showing an anti-reflective film in a display device according to an embodiment of the present disclosure.

FIG. 12 is a view showing an anti-reflective film in a display device according to an embodiment of the present disclosure.

FIG. 13 is a view showing an anti-reflective film in a display device according to an embodiment of the present disclosure.

FIG. 14 is a block diagram of an electronic device according to an embodiment of the present disclosure.

FIG. 15 is a view showing electronic devices according to embodiments of the present disclosure.

### DETAILED DESCRIPTION OF EMBODIMENTS

The advantages and features of the present disclosure, and the methods for achieving them, will become clear with reference to the non-limiting embodiments described below in detail with the accompanying drawings. However, the present disclosure is not limited to the described embodiments, but may be implemented in various different forms.

When elements or layers are referred to as “on” another element or layer, this includes all cases where another layer or another element is interposed directly over or in the middle of the other element. When elements or layers are referred to as “directly on” another element or layer, no intervening elements may be present. The same reference numerals refer to the same components throughout the specification. The shapes, sizes, ratios, angles, numbers, etc. disclosed in the drawings for explaining embodiments are examples, and therefore the present invention is not necessarily limited to the matters illustrated.

Although the terms “first” and “second” are used to describe various components, these components are not limited by these terms. These terms are only used to distinguish one component from another. Therefore, it goes without saying that the first component mentioned below may be the second component within the technical idea of the present invention.

Each of the features of the various embodiments of the present disclosure may be partially or wholly combined or combined with each other, and various technical connections and operations are possible, and each embodiment may be implemented independently of each other or may be implemented together in a related relationship.

Specific embodiments will be described below with reference to the attached drawings.

Hereinafter, non-limiting embodiments of the present disclosure will be described in detail with reference to the accompanying drawings.

The present disclosure concerns an anti-reflection film including an anti-fingerprint film and a first refractive layer disposed on the anti-fingerprint film. The first refractive layer includes silicon oxide doped with metal in a range of less than or equal to about 3 at %. The doped first refractive layer has an increase in an amount of hydroxyl groups formed on the surface of the first refractive layer contacting the anti-fingerprint film due to an increase in non-bridged oxygen. Therefore, the bonding strength between the first refractive layer and the anti-fingerprint film increases and delamination of the anti-fingerprint film is prevented even when the anti-fingerprint film is exposed to chemicals or repeated physical friction.

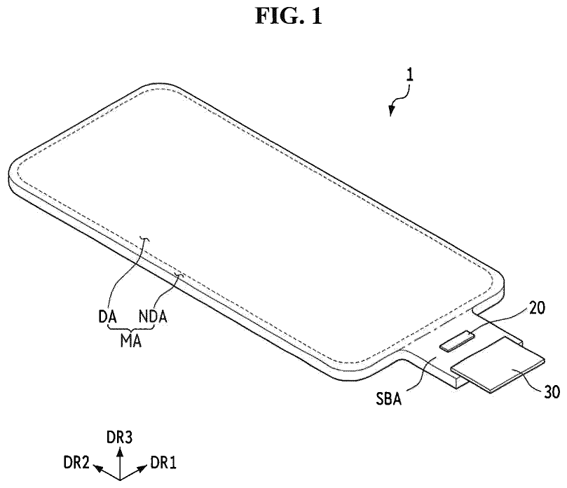

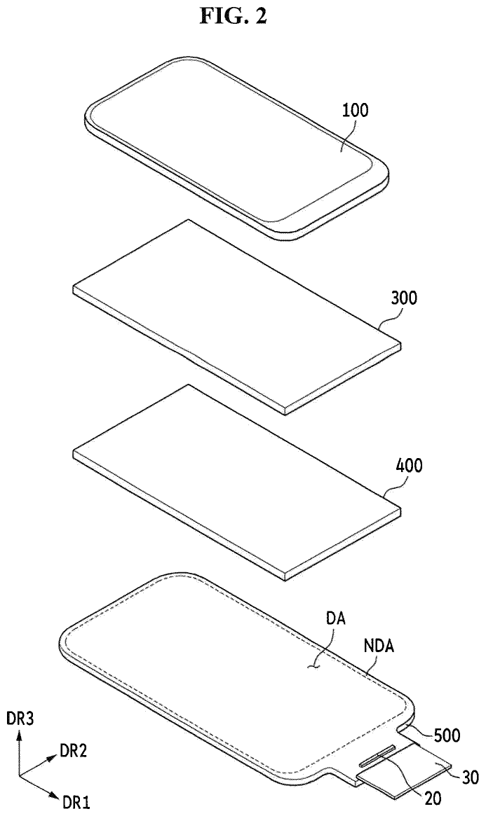

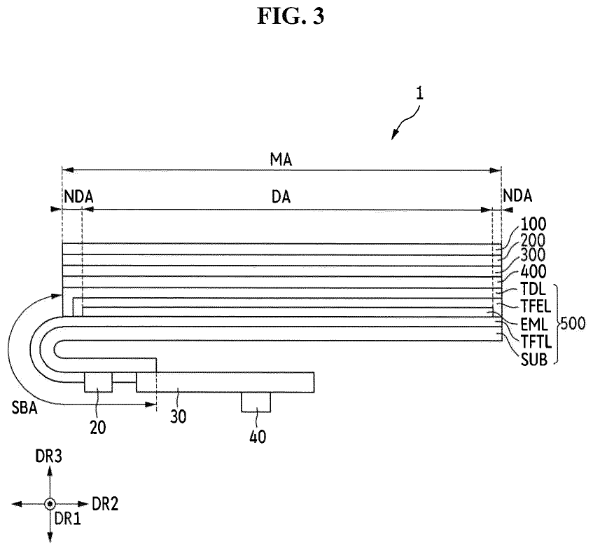

FIG. 1 is a plan view of a display device according to an embodiment of the present disclosure. FIG. 2 is an exploded, perspective view of a display device according to an embodiment of the present disclosure. FIG. 3 is a side view of a display device according to an embodiment of the present disclosure.

Referring to FIGS. 1 to 3, the display device 1 according to an embodiment may include a window member 100, an adhesive member 200, an anti-fingerprint film 300, an anti-reflection film 400 and a display panel 500.

A display device 1 according to an embodiment of the present disclosure is for displaying moving images and/or still images. The display device 1 may be used as the display screen of portable electronic devices such as a mobile phone, a smart phone, a tablet PC, a smart watch, a watch phone, a mobile communications terminal, an electronic notebook, an electronic book, a portable multimedia player (PMP), a navigation device and a ultra mobile PC (UMPC), as well as the display screen of various products such as a television, a notebook, a monitor, a billboard and the Internet of Things. However, embodiments of the present disclosure are not necessarily limited thereto and the electronic device that the display device 1 may be applied to may be various different small-sized, medium-sized or large-sized electronic devices.

According to an embodiment of the present disclosure, the display device 1 may be a light-emitting display device such as an organic light-emitting display device using organic light-emitting diodes, a quantum-dot light-emitting display device including quantum-dot light-emitting layer, an inorganic light-emitting display device including an inorganic semiconductor, and a micro-LED display device using micro or nano light-emitting diodes (micro LEDs or nano LEDs). In the following description, an organic light-emitting display device is described as an example of the display device 1 according to an embodiment of the present. It is, however, to be understood that embodiments of the present disclosure are not necessarily limited thereto.

In an embodiment, the display device 1 includes a display panel 500, a display driver circuit 20 and a circuit board 30.

In an embodiment, the display panel 500 may be formed in a rectangular plane having shorter sides in the first direction DR1 and longer sides in the second direction DR2 intersecting the first direction DR1. In addition, the display panel 500 may have a thickness in the third direction DR3 that intersects the first direction DR1 and the second direction DR2. Each of the corners where the shorter side in the first direction DR1 meets the longer side in the second direction DR2 may be rounded with a curvature or may be a right angle. However, the shape of the display panel 1 when viewed from the top is not necessarily limited to a quadrangular shape, but may be formed in a different polygonal shape, a circular shape, or an elliptical shape. The display panel 1 may be formed flat, but embodiments of the present disclosure are not necessarily limited thereto. For example, the display panel 1 may be formed at left and right ends, and may include a curved portion having a constant curvature or a varying curvature. In addition, the display panel 1 may be flexible so that it can be curved, bent, folded, rolled or otherwise deformed.

The display panel 500 may include the main area MA and a subsidiary area SBA.

The main area MA may include a display area DA where images are displayed, and a non-display area NDA around the display area DA (e.g., in a plan view). The display area DA may occupy most of the main area MA. The display area DA may be arranged at the center of the main area MR. The non-display area NDA may be arranged adjacent to the display area DA. The non-display area NDA may be located on the outer side of the display area DA. The non-display area NDA may surround the display area DA (e.g., in a plan view). The non-display area NDA may be defined as the border of the display panel 500.

In an embodiment, the subsidiary area SBA may be extended from one side of the main area MA in the first direction DR1, such as the lower side of the main area MA in the first direction DR1. The length of the subsidiary area SBA in the first direction DR1 may be less than the length of the main area MA in the first direction DR1. The length of the subsidiary area SBA in the second direction DR2 may be less than the length of the main area MA in the second direction DR2 or may be substantially equal to it. The sub-area SBA may be bent and may be arranged under the display panel 500 (e.g., in a direction opposite to the third direction DR3). In this instance, the subsidiary area SBA may overlap with the main area MA in the third direction DR3.

The display driver circuit 20 may generate signals and voltages for driving the display panel 500. In an embodiment, the display driver circuit 20 may be implemented as an integrated circuit (IC) and may be attached to the subsidiary area SBA of the display panel 500 by a chip on glass (COG) technique, a chip on plastic (COP) technique, or an ultrasonic bonding. Alternatively, the display driver circuit 20 may be attached on the circuit board 30 by the chip-on-film (COF) technique.

The circuit board 30 may be attached to one end of the subsidiary area SBA of the display panel 500, such as a lower end in the first direction DR1. Accordingly, the circuit board 30 may be electrically connected to the display panel 500 and the display driver circuit 20. The display panel 500 and the display driver circuit 20 may receive digital video data, timing signals, and driving voltages through the circuit board 30. The circuit board 30 may be a flexible printed circuit board, a printed circuit board, or a flexible film such as a chip on film.

The touch driver circuit 40 may be arranged on the circuit board 30 (e.g., disposed directly thereon). In an embodiment, the touch driver circuit 40 may be implemented as an integrated circuit (IC) and may be attached on the circuit board 30.

The touch driver circuit 40 may be electrically connected to a plurality of driving electrodes and a plurality of sensing electrodes of the touch detecting layer TDL. The touch driver circuit 40 may apply a touch driving signal to a plurality of driving electrodes, and may sense a touch detection signal, for example, a change in mutual capacitance, of each of a plurality of touch nodes a plurality of sensing electrodes. The touch driver circuit 40 may determine whether there is a user's touch or near proximity (e.g., hover), based on the touch sensing signal of each of the plurality of touch nodes. A user's touch refers to that an object such as the user's finger or a pen is brought into direct contact with the front surface of the display device 1 located on the touch detecting layer TDL. A user's near proximity refers to that an object such as the user's finger and a pen is hovering over the front surface of the display device 1 without directly contacting the front surface of the display device 1.

In an embodiment, the window member 100 may be attached to the front surface of the anti-fingerprint film 300 by the adhesive member 200. The window member 100 is made of a transparent material, and may be, for example, glass or plastic. For example, in an embodiment the window member 100 may be an ultra thin glass (UTG) having a thickness less than or equal to about 0.1 mm or a transparent polyimide film.

The adhesive member 200 may be a transparent adhesive film or a transparent adhesive resin. For example, in an embodiment the adhesive member 200 may include a transparent adhesive such as a pressure sensitive adhesive (PSA) and an optically clear adhesive (OCA). The first adhesive member 200 may include an acrylic adhesive material.

In an embodiment, the anti-fingerprint film 300 may be located on the front surface of the anti-reflection film 400 and the rear surface of the window member 100. The anti-fingerprint film 300 can prevent a user's fingerprint from being left on the display device 1.

The anti-reflection film 400 may be located on the front surface of the display panel 500. The anti-reflection film 400 may include a plurality of refractive layers having different refractive indices from each other. The anti-reflection film 400 can reduce reflected light through the plurality of refractive layers. The anti-reflection film 400 will be described in detail later.

In an embodiment, a light-blocking layer for absorbing light incident from the outside (e.g., the external environment), a buffer layer for absorbing impact from the outside, and a heat-dissipation layer for efficiently discharging heat from the display panel 500 may be further included under the display panel 500.

The light-blocking layer can block transmission of light, thereby preventing elements disposed under the light-blocking layer from being seen from above the display panel 500. The light-blocking layer may include a light-absorbing material such as a black pigment and a black dye.

The buffer layer can absorb external shock to prevent the display panel 500 from being damaged. The buffer layer may be made up of a single layer or multiple layers. For example, the buffer layer may include a polymer resin such as polyurethane, polycarbonate, polypropylene and polyethylene, or may include a material having elasticity such as a rubber and a sponge obtained by foaming a urethane-based material or an acrylic-based material.

In an embodiment, the heat sink layer may include a first heat dissipation layer including graphite or carbon nanotubes, and a second heat dissipation layer formed as a thin metal film such as copper, nickel, ferrite and silver, which can block electromagnetic waves and have high thermal conductivity.

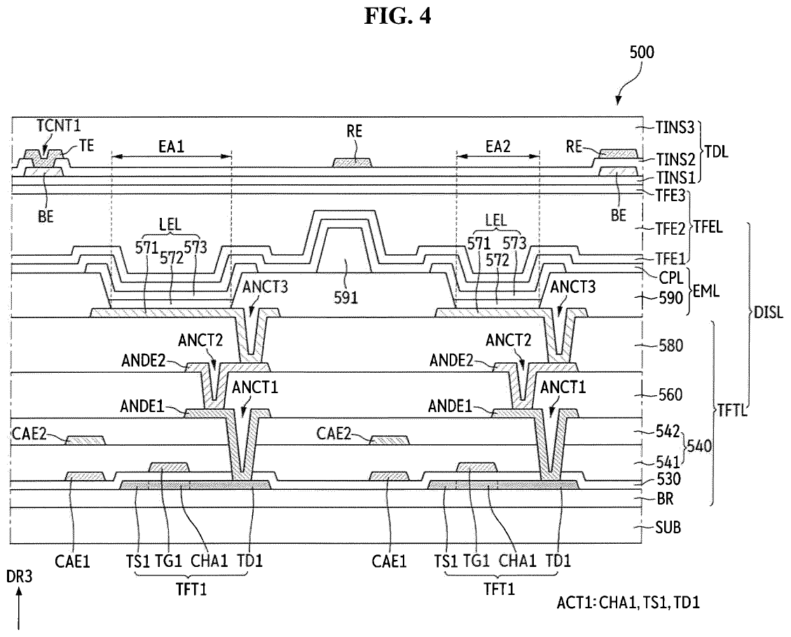

FIG. 4 is a cross-sectional view of a display panel according to an embodiment of the present disclosure.

Referring to FIG. 4, in an embodiment the display panel 500 may include a substrate

SUB, a display layer DISL disposed on the substrate SUB (e.g., disposed directly thereon in the third direction DR3), and a touch detecting layer TDL disposed on the display layer DISL (e.g., disposed directly thereon in the third direction DR3). In an embodiment, the display layer DISL may include a thin-film transistor layer TFTL, an emission material layer EML, and an encapsulation layer TFEL.

The thin-film transistor layer TFTL may be arranged on the substrate SUB (e.g., disposed directly thereon in the third direction DR3). In an embodiment, the thin-film transistor layer TFTL may include a barrier layer BR, a thin-film transistor TFT1, a first capacitor electrode CAE1, a second capacitor electrode CAE2, a first anode connection electrode ANDE1, a second anode connection electrode ANDE2, a gate insulator 530, a first interlayer dielectric film 541, a second interlayer dielectric film 542, a first planarization film 560, and a second planarization film 580.

The substrate SUB may be made of an insulating material such as a polymer resin. For example, the substrate SUB may be made of polyimide. The substrate SUB may be a flexible substrate that can be bent, folded, rolled or otherwise deformed.

The barrier film BR may be arranged on the substrate SUB (e.g., disposed directly thereon in the third direction DR3). The barrier film BR is a film for protecting the thin-film transistors of the thin-film transistor layer TFTL and an emissive layer 572 of the emission material layer EML. In an embodiment, the barrier film BR may be made up of multiple inorganic films stacked on one another alternately. For example, the barrier film BR may be made up of multiple layers in which one or more inorganic layers of a silicon nitride layer, a silicon oxynitride layer, a silicon oxide layer, a titanium oxide layer and an aluminum oxide layer are alternately stacked on one another (e.g., in the third direction DR3).

The thin-film transistor layer TFTL may be arranged on the substrate SUB (e.g., in the third direction DR3). The thin-film transistor layer TFTL may be arranged in the main area MA and the subsidiary area SBA. The thin-film transistor layer TFTL includes thin-film transistors.

The thin-film transistors TFT1 may be arranged on the barrier film BR (e.g., disposed directly thereon in the third direction DR3). An active layer ACT1 of the thin-film transistor TFT1 may be arranged on the barrier layer BR (e.g., disposed directly thereon in the third direction DR3). In an embodiment, the active layer ACT1 of the thin-film transistor TFT1 may include polycrystalline silicon, monocrystalline silicon, low-temperature polycrystalline silicon, amorphous silicon, or an oxide semiconductor.

The active layer ACT1 may include a channel region CHA1, a source region TS1 and a drain region TD1. The channel region CHA1 may overlap with a gate electrode TG1 in the third direction DR3 that is the thickness direction of the substrate SUB. The source region TS1 may be arranged on one side of the channel region CHA1, and the drain region TD1 may be arranged on the opposite side of the channel region CHA1. The source region TS1 and the drain region TD1 may not overlap with the gate electrode TG1 in the third direction DR3. The source region TS1 and the drain region TD1 may be formed by doping a silicon semiconductor or an oxide semiconductor with ions or impurities to have conductivity.

The gate insulator 530 may be arranged on (e.g., disposed directly thereon) the active layer ACT1 of the thin-film transistor TFT1. In an embodiment, the gate insulator 530 may include an inorganic layer, for example, a silicon nitride layer, a silicon oxynitride layer, a silicon oxide layer, a titanium oxide layer, or an aluminum oxide layer.

The gate electrode TG1 of the thin-film transistor TFT1 and the first capacitor electrode CAE1 may be arranged on the gate insulator 530 (e.g., disposed directly thereon in the third direction DR3). The gate electrode TG1 may overlap with the channel region CHA1 in the third direction DR3. Although the gate electrode TG1 and the first capacitor electrode CAE1 are spaced apart from each other in the example shown in FIG. 4, in some embodiments the gate electrode TG1 and the first capacitor electrode CAE1 may be connected with each other as a single piece. In an embodiment, the gate electrode TG1 and the first capacitor electrode CAE1 may be made up of a single layer or multiple layers of one of molybdenum (Mo), aluminum (Al), chromium (Cr), gold (Au), titanium (Ti), nickel (Ni), neodymium (Nd) and copper (Cu) or an alloy thereof.

The first interlayer dielectric film 541 may be arranged on (e.g., disposed directly thereon) the gate electrode TG1 of the thin-film transistor TFT1 and the first capacitor electrode CAE1. In an embodiment, the first interlayer dielectric film 541 may include an inorganic layer, for example, a silicon nitride layer, a silicon oxynitride layer, a silicon oxide layer, a titanium oxide layer, or an aluminum oxide layer. The first interlayer dielectric film 541 may be made of a plurality of inorganic films.

The second capacitor electrode CAE2 may be arranged on the first interlayer dielectric film 541 (e.g., disposed directly thereon in the third direction DR3). The second capacitor electrode CAE2 may overlap the first capacitor electrode CAE1 of the thin-film transistor TFT1 in the third direction DR3. In addition, in an embodiment in which the gate electrode TG1 and the first capacitor electrode CAE1 are formed as a single piece, the second capacitor electrode CAE2 may overlap the gate electrode TG1 in the third direction DR3. Since the first interlayer dielectric film 541 has a dielectric constant, a capacitor can be formed by the first capacitor electrode CAE1, the second capacitor electrode CAE2 and the first interlayer dielectric film 541 arranged therebetween. In an embodiment, the second capacitor electrode CAE2 may be made up of a single layer or multiple layers of one of molybdenum (Mo), aluminum (Al), chromium (Cr), gold (Au), titanium (Ti), nickel (Ni), neodymium (Nd) and copper (Cu) or an alloy thereof.

A second interlayer dielectric film 542 may be arranged over (e.g., directly thereon) the second capacitor electrode CAE2. In an embodiment, the second interlayer dielectric film 542 may include an inorganic layer, for example, a silicon nitride layer, a silicon oxynitride layer, a silicon oxide layer, a titanium oxide layer, or an aluminum oxide layer. The second interlayer dielectric film 542 may be made of a plurality of inorganic films.

A first anode connection electrode ANDE1 may be arranged on the second interlayer dielectric film 542 (e.g., disposed directly thereon in the third direction DR3). In an embodiment, the first anode connection electrode ANDE1 may be connected to the drain electrode DT1 of the thin-film transistor TFT1 through a first connection contact hole ANCT1 that penetrates the gate insulator 530, the first interlayer dielectric film 541 and the second interlayer dielectric film 542. In an embodiment, the first anode connection electrode ANDE1 may be made up of a single layer or multiple layers of one of molybdenum (Mo), aluminum (Al), chromium (Cr), gold (Au), titanium (Ti), nickel (Ni), neodymium (Nd) and copper (Cu) or an alloy thereof.

A first planarization film 560 may be arranged over (e.g., directly thereon) the first anode connection electrode ANDE1 for providing a flat surface over level differences due to the thin-film transistor TFT1. In an embodiment, the first planarization film 560 may include an organic layer such as an acryl resin, an epoxy resin, a phenolic resin, a polyamide resin and a polyimide resin.

A second anode connection electrode ANDE2 may be arranged on the first planarization film 560 (e.g., disposed directly thereon in the third direction DR3). The second anode connection electrode ANDE2 may be connected to the first anode connection electrode ANDE1 through a second connection contact hole ANCT2 penetrating the first planarization film 560. In an embodiment, the second anode connection electrode ANDE2 may be made up of a single layer or multiple layers of one of molybdenum (Mo), aluminum (Al), chromium (Cr), gold (Au), titanium (Ti), nickel (Ni), neodymium (Nd) and copper (Cu) or an alloy thereof.

A second planarization film 580 may be arranged on the second anode connection electrode ANDE2 (e.g., disposed directly thereon in the third direction DR3). In an embodiment, the second planarization film 180 may be formed as an organic layer such as an acryl resin, an epoxy resin, a phenolic resin, a polyamide resin and a polyimide resin.

The emission material layer EML may be arranged on the thin-film transistor layer TFTL (e.g., disposed directly thereon in the third direction DR3). The emission material layer EML may be arranged in the display area DA of the main area MA. The emission material layer EML includes light-emitting elements arranged in emission areas.

An emission material layer EML including light-emitting elements LEL and a bank 590 may be arranged on the second planarization film 580. Each of the light-emitting elements LEL includes a pixel electrode 571, an emissive layer 572, and a common electrode 573.

The pixel electrode 571 may be arranged on the second planarization film 580 (e.g., disposed directly thereon in the third direction DR3). In an embodiment, the pixel electrode 571 may be connected to the second anode connection electrode ANDE2 through a third connection contact hole ANCT3 penetrating the second planarization film 580.

In the top-emission structure in which light exits from the emissive layer 572 towards the common electrode 573, the pixel electrode 571 may be made of a metal material having a high reflectivity such as a stack structure of aluminum and titanium (Ti/Al/Ti), a stack structure of aluminum (Al) and ITO (Indium Tin Oxide) (ITO/Al/ITO), an APC alloy and a stack structure of an APC alloy and ITO (ITO/APC/ITO). The APC alloy is an alloy of silver (Ag), palladium (Pd) and copper (Cu).

The bank 590 may partition the pixel electrode 571 on the second planarization film 580 to define the emission areas EA1 and EA2. In an embodiment, the bank 590 may be arranged to cover the edges of the pixel electrode 571 (e.g., lateral edges). In an embodiment, the bank 590 may include an organic film such as an acryl resin, an epoxy resin, a phenolic resin, a polyamide resin and a polyimide resin.

In each of the first emission area EA1 and the second emission area EA2, the pixel electrode 571, the emissive layer 572 and the common electrode 573 are stacked on one another sequentially (e.g., in the third direction DR3), so that holes from the pixel electrode 571 and electrons from the common electrode 573 are recombined with each other in the emissive layer 572 to emit light.

The emissive layer 572 may be arranged on the pixel electrode 571 and the bank 590. The emissive layer 572 may include an organic material to emit light of a certain color. For example, in an embodiment the emissive layer 572 may include a hole transporting layer, an organic material layer, and an electron transporting layer.

The common electrode 573 may be arranged on the emissive layer 572 (e.g., in the third direction DR3). The common electrode 573 may be arranged to cover the emissive layer 572. In an embodiment, the common electrode 573 may be a common layer formed commonly across the first emission area EA1 and the second emission area EA2.

In the top-emission organic light-emitting diode, the common electrode 573 may include a transparent conductive material (TCP) such as ITO and IZO that can transmit light, or a semi-transmissive conductive material such as magnesium (Mg), silver (Ag) and an alloy of magnesium (Mg) and silver (Ag). When the common electrode 173 is made of a semi-transmissive metal material, the light extraction efficiency can be increased by using microcavities.

A spacer 591 may be arranged on the bank 590 (e.g., disposed directly thereon in the third direction DR3). The spacer 591 may support a mask during a process of fabricating the emissive layer 572. In an embodiment, the spacer 591 may be implemented as an organic layer such as an acryl resin, an epoxy resin, a phenolic resin, a polyamide resin and a polyimide resin.

According to some embodiments of the present disclosure, the display panel 500 may further include a capping layer CPL arranged on (e.g., disposed directly thereon) the common electrode 573. The capping layer CPL may be made of an inorganic material. For example, in an embodiment the capping layer CPL may include at least one of: silicon nitride, aluminum nitride, zirconium nitride, titanium nitride, hafnium nitride, tantalum nitride, silicon oxide, aluminum oxide, titanium oxide, tin oxide, cerium oxide and silicon oxynitride.

The encapsulation layer TFEL may be arranged on the emission material layer EML (e.g., disposed directly thereon in the third direction DR3). The encapsulation layer TFEL may be arranged in the display area DA and the non-display area NDA of the main area MA. The encapsulation layer TFEL includes at least one inorganic film and at least one organic film for encapsulating the emission material layer.

An encapsulation layer TFEL may be arranged on the common electrode 573 (e.g., disposed directly thereon in the third direction DR3). In an embodiment, the encapsulation layer TFEL may include at least one inorganic layer to prevent permeation of oxygen or moisture into the emission material layer EML. In addition, the encapsulation layer TFEL may include at least one organic film to protect the emission material layer EML from particles such as dust. For example, in an embodiment the encapsulation layer TFEL may include a first inorganic encapsulation layer TFE1, an organic encapsulation layer TFE2 and a second inorganic encapsulation layer TFE3.

The first inorganic encapsulation film TFE1 may be arranged on the common electrode 573, the organic encapsulation film TFE2 may be arranged on the first inorganic encapsulation film TFE1, and the second inorganic encapsulation film TFE3 may be arranged on the organic encapsulation film TFE2. In an embodiment, the first inorganic encapsulation film TFE1 and the second inorganic encapsulation film TFE3 may be made up of multiple layers in which one or more inorganic layers of a silicon nitride layer, a silicon oxynitride layer, a silicon oxide layer, a titanium oxide layer and an aluminum oxide layer are alternately stacked on one another (e.g., in the third direction DR3). The organic encapsulation film TFE2 may be an organic film such as an acryl resin, an epoxy resin, a phenolic resin, a polyamide resin, a polyimide resin, etc.

A touch detecting layer TDL may be arranged on the encapsulation layer TFEL (e.g., disposed directly thereon in the third direction DR3). In an embodiment, the touch detecting layer TDL includes a first touch insulating film TINS1, connection electrodes BE, a second touch insulating film TINS2, the driving electrodes TE, the sensing electrodes RE, and a third touch insulating film TINS3. The touch detecting layer TDL may sense a touch of a person or an object using sensor electrodes.

The first touch insulating film TINS1 may be arranged on the encapsulation layer TFEL (e.g., disposed directly thereon in the third direction DR3). In an embodiment, the first touch insulating film TINS1 may be implemented as an inorganic film, for example, a silicon nitride layer, a silicon oxynitride layer, a silicon oxide layer, a titanium oxide layer, or an aluminum oxide layer.

The connection electrode BE may be arranged on the first touch insulating film TINS1 (e.g., disposed directly thereon in the third direction DR3). In an embodiment, the connection electrode BE may be made up of a single layer or multiple layers of one of molybdenum (Mo), aluminum (Al), chromium (Cr), gold (Au), titanium (Ti), nickel (Ni), neodymium (Nd) and copper (Cu) or an alloy thereof.

The second touch insulating film TINS2 may be arranged over (e.g., directly thereon) the connection electrodes BE. In an embodiment, the second touch insulating layer TINS2 may be implemented as an inorganic layer, for example, a silicon nitride layer, a silicon oxynitride layer, a silicon oxide layer, a titanium oxide layer, or an aluminum oxide layer. Alternatively, the second touch insulating layer TINS2 may be made of an organic layer such as an acryl resin, an epoxy resin, a phenolic resin, a polyamide resin and a polyimide resin.

The driving electrodes TE and the sensing electrodes RE may be arranged on the second touch insulating film TINS2 (e.g., disposed directly thereon in the third direction DR3). In an embodiment, the driving electrodes TE and the sensing electrodes RE may be made up of a single layer or multiple layers of one of molybdenum (Mo), aluminum (Al), chromium (Cr), gold (Au), titanium (Ti), nickel (Ni), neodymium (Nd) and copper (Cu) or an alloy thereof.

The driving electrodes TE and the sensing electrodes RE may overlap with the connection electrodes BE in the third direction DR3. In an embodiment, the driving electrodes TE may be connected to the connection electrodes BE through touch contact holes TCNT1 penetrating through the first touch insulating film TINS1.

The third touch insulating film TINS3 may be formed on (e.g., disposed directly thereon) the driving electrodes TE and the sensing electrodes RE. The third touch insulating layer TINS3 may provide a flat surface over the driving electrodes TE, the sensing electrodes RE and the connection electrodes BE which may have different heights from each other. In an embodiment, the third touch insulating film TINS3 may be made of an organic layer such as an acryl resin, an epoxy resin, a phenolic resin, a polyamide resin and a polyimide resin.

Hereinafter, various embodiments of an anti-reflection film 400 according to an embodiment of the present disclosure will be described with reference to the accompanying drawings.

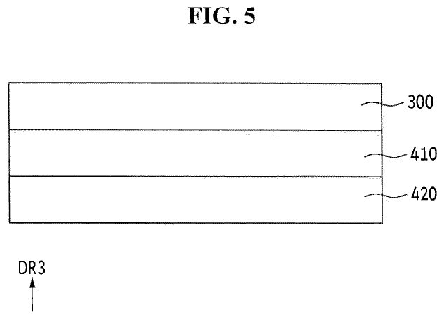

FIG. 5 is a cross-sectional view showing an anti-reflection film in a display device according to a first embodiment of the present disclosure.

Referring to FIG. 5, an anti-reflection film 400 according to an embodiment may include an anti-fingerprint film 300, a first refractive layer 410, and a second refractive layer 420. The first refractive layer 410 may be arranged on a first surface of the anti-fingerprint film 300 (e.g., disposed directly thereon in a direction opposite to the third direction DR3). External light incident from the outside may be incident on a second surface of the anti-fingerprint film 300 opposite to the first surface of the anti-fingerprint film. The second refractive layer 420 may be arranged on the first refractive layer 410 (e.g., disposed directly thereon in a direction opposite to the third direction DR3).

In an embodiment, the refractive index of the first refractive layer 410 may be less than the refractive index of the second refractive layer 420. The first refractive layer 410 may function as a low-refractive layer. The second refractive layer 420 may function as a high-refractive layer.

In an embodiment, the refractive index of the low-refractive layer 410 may be in a range from about 1.20 to about 1.60, but embodiments of the present disclosure are not necessarily limited thereto. The low-refractive layer 410 may include, but is not necessarily limited to, at least one of silicon resin, silica, silicon oxide (SiOx), and silicon dioxide (SiO₂). The low-refractive layer 410 is not necessarily limited to the above-listed materials and may include any material as long as it can exhibit a low refractive index.

In an embodiment, the refractive index of the high-refractive layer 420 may be in a range from about 1.70 to about 2.80, but embodiments of the present disclosure are not necessarily limited thereto.

In an embodiment, the high-refractive layer 420 may include at least one of: silicon nitride (Si₃N₄), aluminum nitride (AlN), zirconium nitride (ZrN), chromium nitride (CrN), titanium nitride (TiN), manganese nitride (Mn₄N), iron nitride (FeNx), cobalt nitride (CoNx), nickel nitride (Ni₃N), copper nitride (Cu₃N), zinc nitride (Zn₂N₃), vanadium nitride (VN), molybdenum nitride (Mo₂N), hafnium nitride (HfN), germanium nitride (Ge₃N₄), lead nitride (Pb(N₃)₂), titanium niobate (Ti₄Nb₃O₃₅), titanium dioxide (TiO₂), zirconium dioxide (ZrO₂), lithium niobate (LiNbO₃), lithium tantalate (LiTaO₃), and Lanthanum Titanium (LaTiO₂). The high-refractive layer 420 is not necessarily limited to the above-listed materials and may include various other materials that exhibit a high refractive index.

The thickness t1 (e.g., length in the third direction DR3) of the first refractive layer 410 and the thickness t2 (e.g., length in the third direction DR3) of the second refractive layer 420 may be equal to each other or different from each other. In an embodiment, the thickness t1 of the first refractive layer 410 and the thickness t2 of the second refractive layer 420 may be determined by considering the characteristics of the anti-reflection film 400, such as the target reflection wavelength, hardness, durability, and reflectance.

In an embodiment, the thickness t1 of the first refractive layer 410 and the thickness t2 of the second refractive layer 420 may be calculated as Equation 1 below:

$$t = \frac{λ}{4 n} \qquad [ Equation 1 ]$$

where t denotes the thickness t1 or t2 of the first refractive layer 410 or the second refractive layer 420 in the anti-reflection film 400, λ denotes the target reflection wavelength of the anti-reflection film 400, and n denotes the refractive index of the first refractive layer 410 or the second refractive layer 420.

For example, when the target reflection wavelength of the anti-reflection film 400 is 500 nm, and the refractive index of the first refractive layer 410 is 1.2, the thickness of the first refractive layer 410 may be approximately 104 nm. For example, when the target reflection wavelength of the anti-reflection film 400 is 500 nm and the refractive index of the second refractive layer 420 is 2.3, the thickness of the first refractive layer 410 may be approximately 54 nm.

In an embodiment, the first refractive layer 410 may be doped with a metal in a range of less than or equal to about 3 at %. The first refractive layer 410 may be doped with a metal in a range of less than or equal to about 3 at %. The first refractive layer 410 may include silicon oxide (SiOx) doped with metal in a range of less than or equal to about 3 at %.

If the first refractive layer 410 is doped with metal having a range that is greater than about 3 at %, the reflection efficiency may be reduced.

In an embodiment, the metal may include at least one of zirconium (Zr), titanium (Ti), aluminum (Al), hafnium (Hf), gallium (Ga), and indium (In).

The metal may include two or more different metals. For example, the first refractive layer 410 may include silicon oxide (SiOx) doped with zirconium (Zr) and aluminum (Al) in a range of less than or equal to about 3 at %.

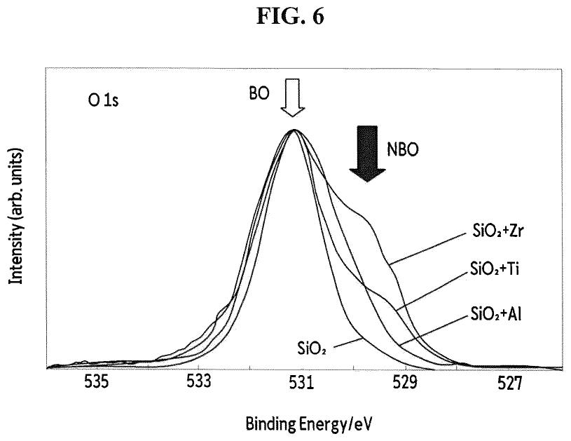

FIG. 6 is an x-ray photoelectron spectroscopy (XPS) graph when metal (Zr, Yi, Al) is doped into silicon oxide (SiO₂) according to an embodiment.

It can be seen from the results of FIG. 6 that non-bridged oxygen (NBO) increases as metal is doped into silicon oxide (SiO₂). The amount of non-bridged oxygen may vary depending on the type of metal.

When a metal is doped into the silicon oxide (SiOx) included in the first refractive layer (410), non-bridging oxygen may increase due to the doped metal. As the non-bridged oxygen increases, hydroxyl groups (—OH) may increase on the surface of the silicon oxide (SiOx). As the non-bridged oxygen increases, the reactivity of the surface of the silicon oxide (SiOx) may increase.

In an embodiment, the anti-fingerprint film 300 may include a compound having at least one silanol at a terminal. For example, the anti-fingerprint film 300 may include a carbon chain having at least one silanol at a terminal. The anti-fingerprint film 300 may include a linear or branched, saturated or unsaturated carbon chain having at least one silanol at a terminal.

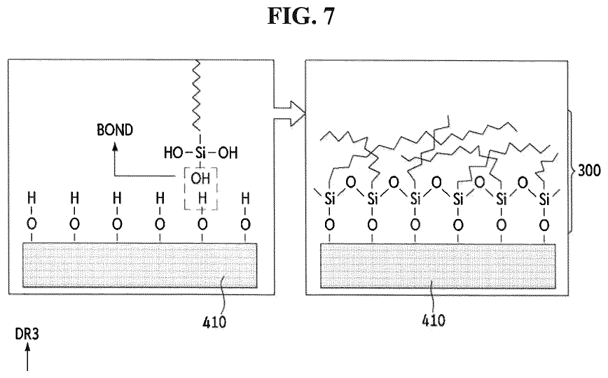

FIG. 7 is a view showing a method for forming an anti-fingerprint film on a first refractive layer according to an embodiment.

Referring to FIG. 7, if a first refractive layer 410 includes silicon oxide (SiOx) doped with metal, it can be seen that hydroxyl groups (—OH) are formed on the surface of the first refractive layer 410. The anti-fingerprint film 300 may include a carbon chain having at least one silanol at a terminal. The adhesive strength between the first refractive layer 410 and the anti-fingerprint film 300 may increase as the silanol of the anti-fingerprint film 300 and the hydroxyl groups (—OH) on the surface of the first refractive layer 410 bond together. For example, the silanol of the anti-fingerprint film 300 and the hydroxyl groups (—OH) on the surface of the first refractive layer 410 may bond together by condensation reaction.

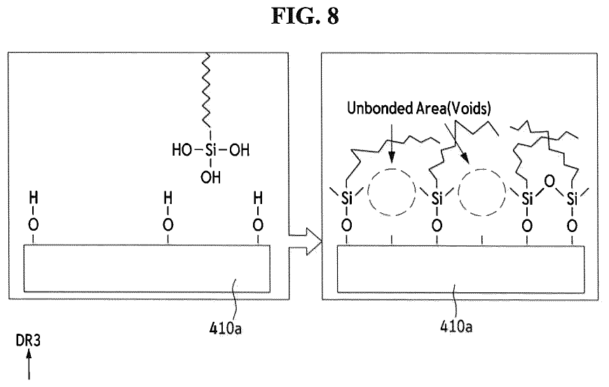

FIG. 8 is a view showing a method for forming an anti-fingerprint film on a first refractive layer according to Comparative Example.

Referring to FIG. 8, if a first refractive layer 410a is made of silicon oxide (SiOx) that is not doped with metal, it can be seen that a less number of hydroxyl groups (—OH) are formed on the surface of the first refractive layer 410a. When silanol of the anti-fingerprint film 300 and hydroxyl groups (—OH) on the surface of the first refractive layer 410a bond together, the first refractive layer 410a and the anti-fingerprint film 300 may fail to bond and thus a defect (void) may occur because the number of hydroxyl groups (—OH) on the surface of the first refractive layer 410a is small. As a result, the bonding strength between the first refractive layer 410a and the anti-fingerprint film 300 may become weak.

If the bonding strength between the first refractive layer 410 and the anti-fingerprint film 300 is weak, delamination may occur. For example, the anti-fingerprint film 300 may fall off due to chemicals or repeated physical friction. To prevent this, it is necessary to increase the bonding strength between the first refractive layer 410 and the anti-fingerprint film 300.

To sum up, if the first refractive layer 410 contains silicon oxide (SiOx) doped with metal in a range of less than or equal to about 5 at %, the non-bridged oxygen increases and accordingly the hydroxyl groups (—OH) on the surface of the first refractive layer 410 increase. As the amount of hydroxyl groups (—OH) that can bond with the silanol of the anti-fingerprint film (300) increases, the bonding strength between the first refractive layer 410 and the anti-fingerprint film 300 can increase.

The metal doped into the first refractive layer 410 may be uniformly distributed inside the first refractive layer 410. For example, in an embodiment the first refractive layer 410 uniformly doped with metal may be fabricated by forming the first refractive layer 410 using silicon oxide (SiOx) uniformly doped with metal at about 3 at % as a target.

In an embodiment, the thickness of the first refractive layer 410 may be less than or equal to about 200 nm. It should be understood, however, that the embodiments of the present disclosure are not necessarily limited thereto. In an embodiment, the thickness of the first refractive layer 410 may be less than or equal to about 100 nm. It should be understood, however, that the embodiments of the present disclosure are not necessarily limited thereto.

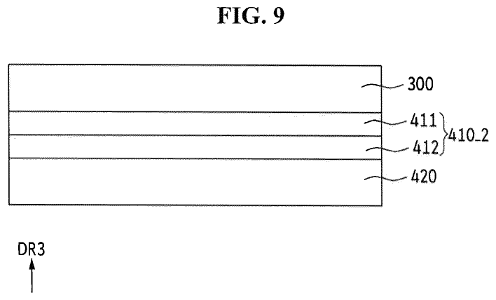

FIG. 9 is a cross-sectional view showing an anti-reflection film in a display device according to an embodiment of the present disclosure.

An anti-reflection film 400 according to an embodiment shown in FIG. 9 is substantially identical to the anti-reflection film 400 according to an embodiment shown in FIG. 5 except that a first refractive layer 410_2 includes a first sub-layer 411 and a second sub-layer 412; and, therefore, the redundant descriptions will be omitted for economy of explanation.

In an embodiment, a second sub-layer 412 containing silicon oxide (SiOx) may be located on a second refractive layer 420 (e.g., disposed directly thereon in the third direction DR3), and a first sub-layer 411 containing silicon oxide (SiOx) doped with metal less than or equal to about 3 at % may be located on the second sub-layer 412 (e.g., disposed directly thereon in the third direction DR3). For example, the second sub-layer 412 may be disposed on a first surface of the first sub-layer 411 that is opposite to (e.g., in the third direction DR3) a second surface of the first sub-layer 411 that is in direct contact with the anti-fingerprint film 300.

In an embodiment, the thickness of the first refractive layer 410_2 may be in a range of about 70 nm to about 200 nm. It should be understood, however, that embodiments of the present disclosure are not necessarily limited thereto. In an embodiment in which the first refractive layer 410 is made up of a single layer as in an embodiment of FIG. 5, the thickness of the first refractive layer 410 may be less than or equal to about 100 nm. In an embodiment in which the first refractive layer 410_2 is made up of multiple layers as in an embodiment of FIG. 9, the thickness of the first sub-layer 411 may be less than or equal to about 100 nm. In an embodiment, the thickness of the first sub-layer 411 may be less than or equal to about 70 nm. It should be understood, however, that embodiments of the present disclosure are not necessarily limited thereto.

The first refractive layer 410, 410_2 is doped with metal in a range of less than or equal to about 3 at %, so that the hydroxyl groups (—OH) on the surface of the first refractive layer 410 increase. As a result, the adhesion with the anti-fingerprint film 300 can be increased. As the adhesive strength between the anti-fingerprint film 300 and the first refractive layer 410, 410_2 is increased, it is possible to prevent delamination of the anti-fingerprint film 300 even when it is exposed to chemicals or repeated physical friction. In this manner, the durability of the anti-reflection film 400 can be increased. To increase the adhesive strength between the anti-fingerprint film 300 and the first refractive layer 410, there may be an increase in the adhesion on the surface of the first refractive layer 410, 410_2 that is in direct contact with the anti-fingerprint film 300. Even when only the first sub-layer 411 that is in direct contact with the anti-fingerprint film 300 is doped with metal in a range of less than or equal to about 3 at % as in an embodiment of FIG. 9, the adhesive strength between the anti-fingerprint film 300 and the first refractive layer 4102) can be sufficiently increased. To increase the adhesion with the anti-fingerprint film 300, the first sub-layer 411 of a certain thickness may have increased adhesion properties, and the thickness of the second sub-layer 412 may be adjusted depending on the target refractive index of the first refractive layer 410_2. In an embodiment in which the first refractive layer 410 is implemented as a single layer as in an embodiment of FIG. 5, the process is relatively simple and the process time can be shortened.

The thickness of the anti-fingerprint film 300 may be less than or equal to about 35 nm. It should be understood, however, that embodiments of the present disclosure are not necessarily limited thereto.

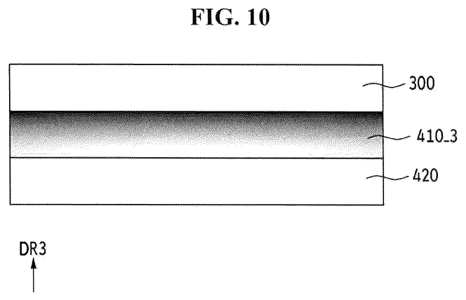

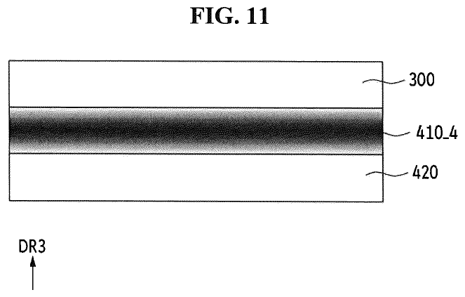

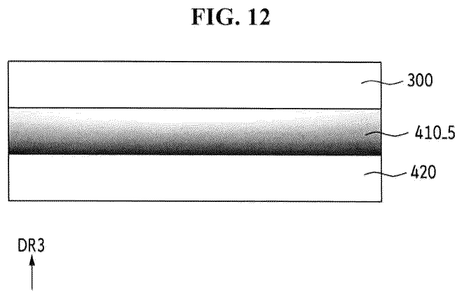

FIG. 10 is a view showing an anti-reflection film in a display device according to an embodiment of the present disclosure. FIG. 11 is a view showing an anti-reflective film in a display device according to an embodiment of the present disclosure. FIG. 12 is a view showing an anti-reflective film in a display device according to an embodiment of the present disclosure.

Anti-reflection films 400 according to embodiments shown in FIGS. 10 to 12 are substantially identical to the anti-reflection film 400 according to an embodiment shown in FIG. 5 except that first refractive layers 410_3, 410_4 and 410_5 are non-uniformly doped with metal (e.g., along the thickness direction of the first refractive layers 410_3, 410_4, 410_5, such as the third direction DR3); and, therefore, the redundant descriptions will be omitted for economy of explanation.

Referring to FIGS. 10 to 12, the first refractive layers 410_3, 410_4 and 410_5 may be non-uniformly doped with metal. The metal may have a gradual concentration gradient in the first refractive layers 410_3, 410_4 and 410_5.

Referring to FIG. 10, in an embodiment, in the first refractive layer 410_3, the metal may have a concentration gradient that gradually increases towards the anti-fingerprint film 300 (e.g., in the third direction DR3). The concentration gradient shown in FIGS. 10-12 is illustrated by a level of the shading in which a darker shading represents an increase in the doping concentration.

Referring to FIG. 11, in an embodiment, in the first refractive layer 410_4, the metal may have a concentration gradient that gradually increases towards the center of the first refractive layer 410_4 (e.g., in a thickness direction of the first refractive layer 410_4, such as the third direction DR3) and decreases towards upper and lower surfaces of the first refractive layer 410_4.

Referring to FIG. 12, in an embodiment, in the first refractive layer 410_5, the metal may have a concentration gradient that gradually decreases towards the anti-fingerprint film 300 (e.g., in the third direction DR3).

In an embodiment, the concentration gradient of the metal in the first refractive layers 410_3, 410_4 and 410_5 may be determined by considering the reflectance of the anti-reflection film 400, the adhesive strength between the first refractive layers 410_3, 410_4 and 410_5 and the anti-fingerprint film 300, etc.

In an embodiment, the first refractive layers 410_3, 410_4 and 410_5 may be doped with metal having a gradual concentration gradient by separately using a silicon oxide (SiOx) target and a metal target depending on the exposure timing and exposure time of the metal target, like the first refractive layers 410_3, 410_4 and 410_5.

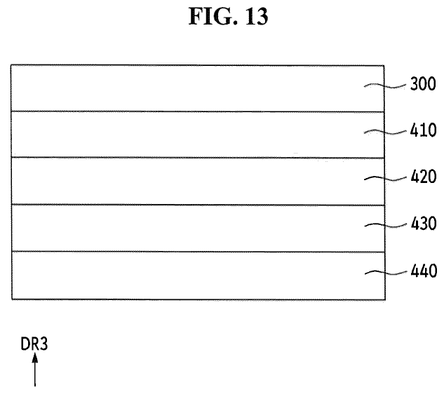

FIG. 13 is a view showing an anti-reflection film in a display device according to an embodiment of the present disclosure.

An anti-reflection film 400 according to an embodiment shown in FIG. 13 is substantially identical to the anti-reflection film 400 according to an embodiment shown in FIG. 5 except that a third refractive layer 430 and a fourth refractive layer 440 are included in the anti-reflection film 400 and, therefore, the redundant descriptions will be omitted for economy of explanation.

In an embodiment, the refractive index of the third refractive layer 430 may be less than the refractive index of the fourth refractive layer 440. The third refractive layer 430 may function as a low-refractive layer. The fourth refractive layer 440 may function as a high-refractive layer. The third refractive layer 430 may have the characteristics of the low-refractive layer listed above. The fourth refractive layer 440 may have the characteristics of the high-refractive layer listed above.

In an embodiment, the anti-reflection film 400 may be arranged in multiple layers by alternating high-refractive layers and low-refractive layers using the distributed Bragg reflector (DBR) characteristics. Although the anti-reflection film 400 in which the first refractive layer 410, the second refractive layer 420, the third refractive layer 430 and the fourth refractive layer 440 are stacked on one another (e.g., in the third direction DR3) is depicted in the drawings, the low-refractive layers 410 and 430 with a low refractive index and the high-refractive layers 420 and 440 with a high refractive index may be arranged alternately in multiple additional layers. For example, in some embodiments, the number of the multiple layers included in the anti-reflection film 400 may be greater than or equal to 8.

Hereinafter, embodiments of the present disclosure will be described in more detail. It should be understood that the described embodiments of the present disclosure are merely illustrative and are not intended to limit the scope of the present disclosure.

### 1. Preparation of Anti-Reflection Film

Anti-reflection films of Examples 1 to 4 and Comparative Example 1 were fabricated with reference to Tables 1 and 2 below.

The anti-fingerprint films were fabricate using silanol having a carbon chain.

In Example 1, silicon oxide (SiO₂) doped with 3 at % zirconium (Zr) was used as the low-refractive layer (first refractive layer) corresponding to the top layer of the anti-reflection film. In Comparative Example 1, silicon oxide (SiO₂) was used as the low-refractive layer (first refractive layer) corresponding to the top layer of the anti-reflection film.

The low-refractive layers (the third, fifth, seventh, ninth and eleventh refractive layers) of Examples 1 to 4 and Comparative Example 1 were stacked using SiO₂ to the thicknesses shown in Tables 1 and 2 below. The high-refractive layers (the second, fourth, sixth, eighth, tenth and twelfth refractive layers) of Examples 1 to 4 and Comparative Example 1 were stacked using Si₃N₄ to the thicknesses shown in Tables 1 and 2 below.

In Examples 2 and 3, silicon oxide (SiO₂) doped with 3 at % zirconium (Zr) was used as the first sub-layer, and silicon oxide (SiO₂) was used as the second sub-layer.

In Example 4, silicon oxide (SiO₂) doped with 1.5 at % zirconium (Zr) was used as the first sub-layer, and silicon oxide (SiO₂) was used as the second sub-layer.

TABLE 1

| Thickness (nm) | Example 1 | Comparative Example 1 |
|---|---|---|
| Anti-Fingerprint Film | 10 | 10 |
| First Refractive Layer | 85 | 85 |
| Second Refractive Layer | 159.5 | 159.5 |
| Third Refractive Layer | 14.5 | 14.5 |
| First Refractive Layer | 186.7 | 186.7 |
| Fourth Refractive Layer | 10.1 | 10.1 |
| Fifth Refractive Layer | 182.6 | 182.6 |
| Sixth Refractive Layer | 10 | 10 |
| Seventh Refractive Layer | 174.6 | 174.6 |
| Eighth Refractive Layer | 13.9 | 13.9 |
| Ninth Refractive Layer | 156.9 | 156.9 |
| Tenth Refractive Layer | 34.8 | 34.8 |
| Eleventh Refractive Layer | 16.6 | 16.6 |
| Twelfth Refractive Layer | 35.6 | 35.6 |
| Total Thickness | 1090 | 1090 |
| Reflectance (%) | 0.51 | 0.52 |
| Surface Wear Resistance | >5K | 3K |

TABLE 2

| Thickness (nm) | Example 2 | Example 3 | Example 4 |
|---|---|---|---|
| Anti-Fingerprint Film | 10 | 10 | 10 |
| First Sub-Layer | 40 | 25 | 40 |
| Second Sub-Layer | 45 | 58 | 43 |
| Second Refractive Layer | 159.5 | 272 | 273 |
| Third Refractive Layer | 14.5 | 242.2 | 17 |
| Fourth Refractive Layer | 186.7 | 50 | 171.2 |
| Fifth Refractive Layer | 10.1 | 16.2 | 30.7 |
| Sixth Refractive Layer | 182.6 | 194.1 | 44.2 |
| Seventh Refractive Layer | 10 | 15.7 | 28.8 |
| Eighth Refractive Layer | 174.6 | 29.2 | 64.3 |
| Ninth Refractive Layer | 13.9 | 40 | 22.1 |
| Tenth Refractive Layer | 156.9 | 9.5 | 41.4 |
| Eleventh Refractive Layer | 34.8 | 10 | 44.4 |
| Twelfth Refractive Layer | 16.6 | | 14 |
| Thirteenth Refractive Layer | 35.6 | | 24.1 |
| Total Thickness (nm) | 1090 | 753 | 868 |
| Reflectance (%) | 0.51 | 0.42 | 0.43 |
| Surface Wear Resistance | >5K | >4K | >4K |

In Tables 1 and 2, the surface wear resistance denotes the number of times the surface of the anti-reflection film is rubbed with a steel wool until delamination occurs on the surface of the anti-reflection film. For example, the number >5K as in Example 1 means that delamination has not occurred even after the anti-reflection film was rubbed with a steel wool more than 5,000 times. For example, the number 3K as in Example 1 means that delamination has occurred after the anti-reflection film was rubbed with a steel wool 3,000 times.

### [Evaluation]

### 1. Reflectance and Surface Wear Resistance

It can be seen from the results shown in Tables 1 and 2 that the reflectances of Examples 1 to 4 and Comparative Example 1 are all less than 1%. It can be seen that when the first refractive layer 410 is doped with metal in a range of less than or equal to about 3 at %, there is no effect on the reflectance.

It can be seen from the results shown in Tables 1 and 2 that the surface wear resistance of Comparative Example 1 is less than or equal to 3K, while the surface wear resistance of Examples 1 to 4 is greater than or equal to 4K.

In particular, it can be seen that the surface wear resistance of Example 1, in which silicon oxide (SiO₂) doped with 3 at % zirconium (Zr) was used as a single layer of the first refractive layer, is similar to the surface wear resistance of Example 2 having the multilayer structure, in which silicon oxide (SiO₂) doped with 3 at % zirconium (Zr) was used as a first sub-layer with a smaller thickness. This is because the bonding strength between the surface of the first refractive layer and the surface of the anti-fingerprint film is enhanced as the metal is doped into silicon oxide (SiO₂). This may mean that the wear resistance of the anti-reflection film increases when the thickness of the first refractive layer in contact with the anti-fingerprint film is equal to or greater than a certain value.

As in Example 3, it can be seen that wear resistance of 4K or higher is achieved even when silicon oxide (SiO₂) doped with 3 at % zirconium (Zr) has the thickness of 25 nm.

As in Example 4, it can be seen that the wear resistance of 4K or higher is achieved even when silicon oxide (SiO₂) doped with zirconium (Zr) at a low concentration, e.g., 1.5 at %.

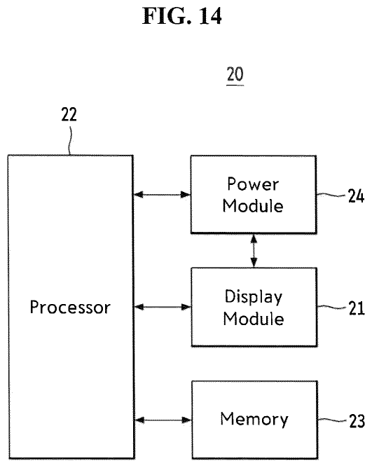

FIG. 14 is a block diagram of an electronic device according to an embodiment of the present disclosure. Referring to FIG. 14, an electronic device 20 according to an embodiment of the present disclosure may include a display module 21, a processor 22, a memory 23, and a power module 24.

The processor 22 may include at least one of: a central processing unit (CPU), an application processor (AP), a graphic processing unit (GPU), a communication processor (CP), an image signal processor (ISP), and a controller.

The memory 23 may store data information required for the operation of the processor 22 or the display module 21. When the processor 22 executes an application stored in the memory 23, an image data signal and/or an input control signal may be transmitted to the display module 21. The display module 21 may process the received signal and output image information through a display screen.

The power module 24 may include a power supply module such as a power adapter and a battery device, and a power conversion module that converts the power supplied by the power supply module to generate power required for the operation of the electronic device 20.

At least one of the elements of the electronic device 20 described above may be included in the display device 1 according to embodiments described above. In addition, some of the individual modules functioning as a single module may be included in the display device 1 while some others may be provided separately from the display device 1. For example, the display device 1 may include the display module 21, and the processor 22, the memory 23 and the power module 24 may be provided as other devices inside the electronic device 20 than the display device 1.

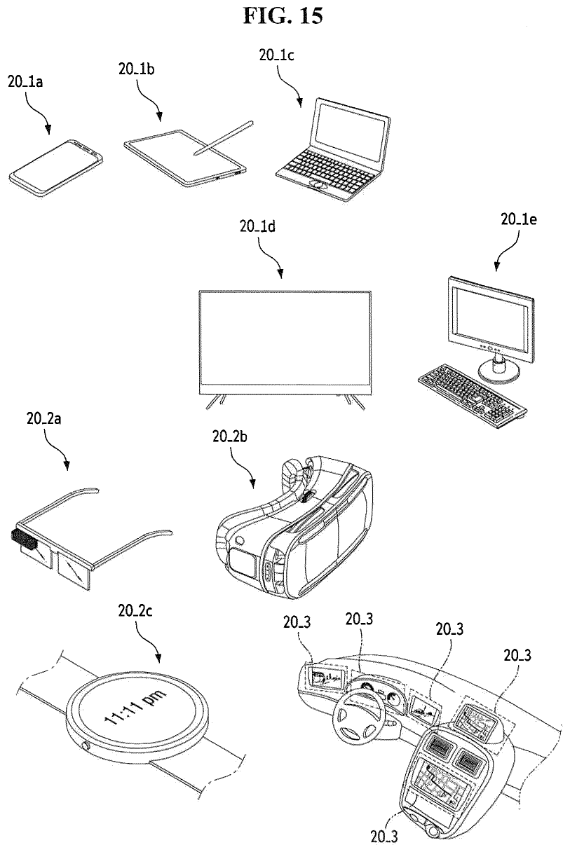

FIG. 15 is a view showing electronic devices according to a variety of embodiments of the present disclosure.

Referring to FIG. 15, a variety of electronic devices 20 employing the display devices according to the embodiments may include not only electronic devices for display images such as a smart phone 20_1a, a tablet PC 20_1b, a laptop computer 20_1c, a TV 20_1d and a desktop monitor 20_1e, but also wearable electronic devices including display modules such as smart glasses 20_2a, a head-mounted display 20_2b and a smart watch 20_2c, and electronic devices for vehicles 20_3 including display modules such as a center information display (CID) placed on the dashboard, the center fascia and the dashboard of a vehicle, and a room mirror display.

Although non-limiting embodiments of the present invention have been described with reference to the attached drawings, those skilled in the art will understand that the present disclosure can be implemented in other specific forms without changing the technical idea or essential features of the present disclosure. Therefore, it should be understood that embodiments described above are non-limiting in all respects and not restrictive.

What is claimed is:

1. An anti-reflection film comprising:
an anti-fingerprint film;
a first refractive layer arranged on a first surface of the anti-fingerprint film; and
a second refractive layer arranged on the first refractive layer,
wherein a refractive index of the first refractive layer is less than a refractive index of the second refractive layer, and the first refractive layer comprises silicon oxide (SiOₓ) doped with metal in a range of less than or equal to about 3 at %.

2. The anti-reflection film of claim 1, wherein light is incident from outside on a second surface of the anti-fingerprint film that is opposite to the first surface of the anti-fingerprint film.

3. The anti-reflection film of claim 1, wherein the metal comprises at least one compound selected from zirconium (Zr), titanium (Ti), aluminum (Al), hafnium (Hf), gallium (Ga), and indium (In).

4. The anti-reflection film of claim 1, wherein the anti-fingerprint film comprises a compound having at least one silanol at a terminal,
wherein a hydroxyl group (—OH) is formed on a surface of the first refractive layer, and
wherein the silanol bonds with the hydroxyl group (—OH).

5. The anti-reflection film of claim 1, wherein the first refractive layer is uniformly doped with the metal.

6. The anti-reflection film of claim 1, wherein a thickness of the first refractive layer is less than or equal to about 200 nm.

7. The anti-reflection film of claim 1, wherein the first refractive layer comprises:
a first sub-layer comprising silicon oxide (SiOₓ) doped with the metal in the range of less than or equal to about 3 at %; and
a second sub-layer located on a first surface of the first sub-layer and comprising the silicon oxide (SiOₓ), and
wherein a second surface of the first sub-layer that is opposite to the first surface of the first sub-layer is in direct contact with the anti-fingerprint film.

8. The anti-reflection film of claim 7, wherein:
a thickness of the first refractive layer is in a range from about 70 nm to about 200 nm; and
a thickness of the first sub-layer is less than or equal to about 100 nm.

9. The anti-reflection film of claim 1, wherein a thickness of the anti-fingerprint film is less than or equal to about 35 nm.

10. The anti-reflection film of claim 1, wherein the first refractive layer is non-uniformly doped with the metal.

11. The anti-reflection film of claim 10, wherein the metal has a gradual concentration gradient in the first refractive layer.

12. The anti-reflection film of claim 11, wherein the gradual concentration gradient increases towards the anti-fingerprint film.

13. The anti-reflection film of claim 11, wherein the gradual concentration gradient decreases towards the anti-fingerprint film.

14. The anti-reflection film of claim 11, wherein the gradual concentration gradient increases towards a center of the first refractive layer in a thickness direction of the first refractive layer.

15. The anti-reflection film of claim 1, further comprising:
a third refractive layer located on the second refractive layer; and
a fourth refractive layer located on the third refractive layer,
wherein a refractive index of the third refractive layer is less than a refractive index of the fourth refractive layer.

16. A display device comprising:
a display panel;
an anti-reflection film arranged on the display panel; and
a window member arranged on the anti-reflection film,
wherein the anti-reflection film comprises:
an anti-fingerprint film;
a first refractive layer arranged on a first surface of the anti-fingerprint film; and
a second refractive layer arranged on the first refractive layer, and
wherein a refractive index of the first refractive layer is less than a refractive index of the second refractive layer, the window member is arranged on a second surface of the anti-fingerprint film opposite to the first surface of the anti-fingerprint film, and the first refractive layer comprises silicon oxide (SiOₓ) doped with metal in a range of less than or equal to about 3 at %.

17. The display device of claim 16, wherein the first refractive layer comprises:
a first sub-layer comprising silicon oxide (SiOₓ) doped with the metal in the range of less than or equal to about 3 at %; and
a second sub-layer located on a first surface of the first sub-layer and comprising the silicon oxide (SiOₓ), and
wherein a second surface of the first sub-layer that is opposite to the first surface of the first sub-layer is in direct contact with the anti-fingerprint film.

18. The display device of claim 16, wherein the metal has a gradual concentration gradient in the first refractive layer.

19. The display device of claim 16, further comprising:
a third refractive layer located on the second refractive layer; and
a fourth refractive layer located on the third refractive layer,
wherein a refractive index of the third refractive layer is less than a refractive index of the fourth refractive layer.

20. An electronic device comprising:
a display device for displaying images,
wherein the display device comprises: a display panel;
an anti-reflection film arranged on the display panel; and
a window member arranged on the anti-reflection film,
wherein the anti-reflection film comprises:
an anti-fingerprint film;
a first refractive layer arranged on a first surface of the anti-fingerprint film; and
a second refractive layer arranged on the first refractive layer, and
wherein a refractive index of the first refractive layer is less than a refractive index of the second refractive layer, the window member is arranged on a second surface of the anti-fingerprint film opposite to the first surface of the anti-fingerprint film, and the first refractive layer comprises silicon oxide (SiOx) doped with metal in a range of less than or equal to about 3 at %.
